(19) United States
(12) Patent Application Publication
(10) Pub. No.: US 2007/0222913 A1
(43) Pub. Date: Sep. 27, 2007

(54) Web pad for preventing damage to internal components

(75) Inventors: Sang Geun Choi, Gwangsan-gu (KR); Tae Ho Joo, Gwangsan-gu (KR); Jong Hoon Oh, Gwangsan-gu (KR); Hyoung Min Go, Gwangsan-gu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/698,201

(22) Filed: Jan. 26, 2007

(30) Foreign Application Priority Data
Mar. 11, 2006 (KR) 2006-22904

(51) Int. Cl. G02F 1/1333; G02F 1/1335

(52) U.S. Cl. 349/58; 349/12

(57) ABSTRACT

A web pad includes an LCD module having an LCD and a touch screen; a main board driving the LCD module; a case unit containing the LCD module and the main board therein; fixing bosses formed on the case unit fixing the LCD module; nuts, each of which is inserted into a corresponding fixing boss, providing reinforcement of the fixing bosses preventing damage to the fixing bosses due to impact; and screws connecting the LCD module to the nuts. The web pad prevents damage to internal components, including the LCD panel installed in the web pad, due to breakage of the fixing bosses from external impact.

### CROSS-REFERENCE TO RELATED APPLICATIONS

This application claims the benefit of Korean Patent Application No. 2006-0022904, filed Mar. 11, 2006, in the Korean Intellectual Property Office, the disclosure of which is incorporated herein by reference.

### BACKGROUND OF THE INVENTION

1. Field of the Invention

The present invention relates to a web pad, and more particularly, to a web pad having a structure that prevents damage to internal components due to external impact.

2. Description of the Related Art

Generally, a web pad is a handheld wireless device having a size generally smaller than that of a notebook computer, but generally larger than that of a personal digital assistant (PDA). The web pad is able to perform various operations, such as transmission and reception of e-mail, word processing, and is able to function as an electronic book, by allowing a user to write on a small-sized liquid crystal display (LCD) using a pen-recognition touch screen. As high-speed large-capacity data wireless communication technique has become more common recently, the web pad has more recently been used together with the PDA.

The web pad, which is generally less expensive than a personal computer, can be employed for use in various fields, such as cyber trading, fleet management, geographic data processing, internet broadcasting, and gaming. Further, the web pad is able to be used anywhere that provides a web connection, such as in a home, a public institution, or an exhibition area. Particularly, the web pad is useful in home automation and has been watched more recently for use in information communication. For example, a refrigerator having a web pad installed on a front door thereof has already come into the market.

An LCD panel provided in the web pad is generally fixed to the case of the web pad by connecting a plurality of fixing holes formed in the circumferential surface of the LCD panel to boss portions formed on the case and inserting screws into the boss portions.

However, as the web pad is often carried by a user, the web pad may be dropped by the user's carelessness. The boss portions of the case that fix the LCD panel to the case are then generally broken due to impact when the web pad is dropped, and the LCD panel may be damaged or broken, or internal components installed in the web pad may be broken.

Since the boss portions are formed integrally with the case, which is generally made of plastic, the torques of the screws inserted into the boss portions may be different, thus causing a difference of heights between fixing portions and generating defects on an LCD screen, such as ripples.

If the LCD panel is not fixed correctly, defects on a touch screen of the LCD due to a positional deviation may occur.

### SUMMARY OF THE INVENTION

Therefore, one aspect of the invention is to provide a web pad having a structure that prevents against damage to internal components including an LCD panel, due to external impact, and defects occurring on an LCD screen.

Additional aspects and/or advantages of the invention will be set forth in part in the description which follows and, in part, will be apparent from the description, or may be learned by practice of the invention.

The foregoing and/or other aspects are achieved by providing a web pad including a case unit having a space formed therein; an LCD module including an LCD and a touch screen; and a main board provided in the case, wherein the case unit includes a plurality of fixing bosses, into which nuts are inserted, formed thereon so that screws are connected with the corresponding nuts, fixing the LCD module.

The nuts may be made of a metal.

Support portions supporting the fixing bosses may be formed on each of the fixing bosses.

Guide protrusions guiding the position of the LCD module upon installation may be formed on the case.

An isolating portion preventing contact between the touch screen and the case unit may be formed in the case unit.

The foregoing and/or other aspects are also achieved by providing a web pad having an LCD module including an LCD and a touch screen; a main board for driving the LCD module; a case unit containing the LCD module and the main board therein; fixing bosses formed on the case unit fixing the LCD module; nuts inserted into the corresponding fixing bosses to prevent damage to the fixing bosses due to impact; and screws connecting the LCD module to the nuts.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a perspective view of a web pad in accordance with an embodiment of the present invention;

FIG. 2 is an exploded perspective view of the web pad in accordance with the embodiment of the present invention;

FIG. 3 is a plan view of the web pad in accordance with the embodiment of the present invention, in a state in which a front case and an LCD module are connected; and

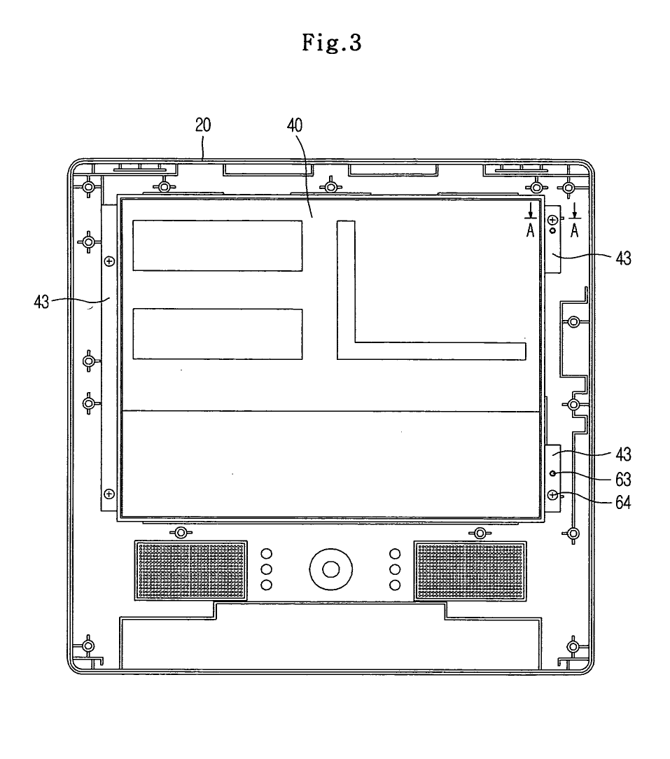

FIG. 4 is a sectional view taken along the line A-A′ of FIG. 3.

### DETAILED DESCRIPTION OF THE PREFERRED EMBODIMENT

Reference will now be made in detail to the embodiment of the present invention, an example of which is illustrated in the accompanying drawings, wherein like reference numerals refer to like elements throughout. The embodiment is described below to explain the present invention by referring to the annexed drawings.

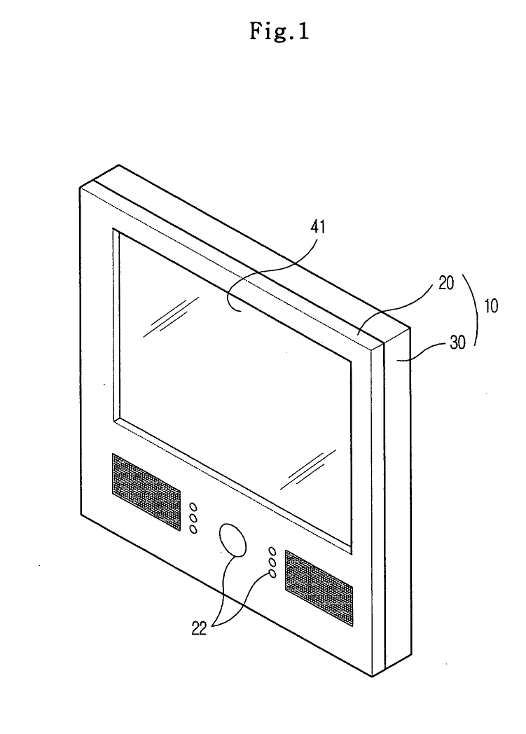

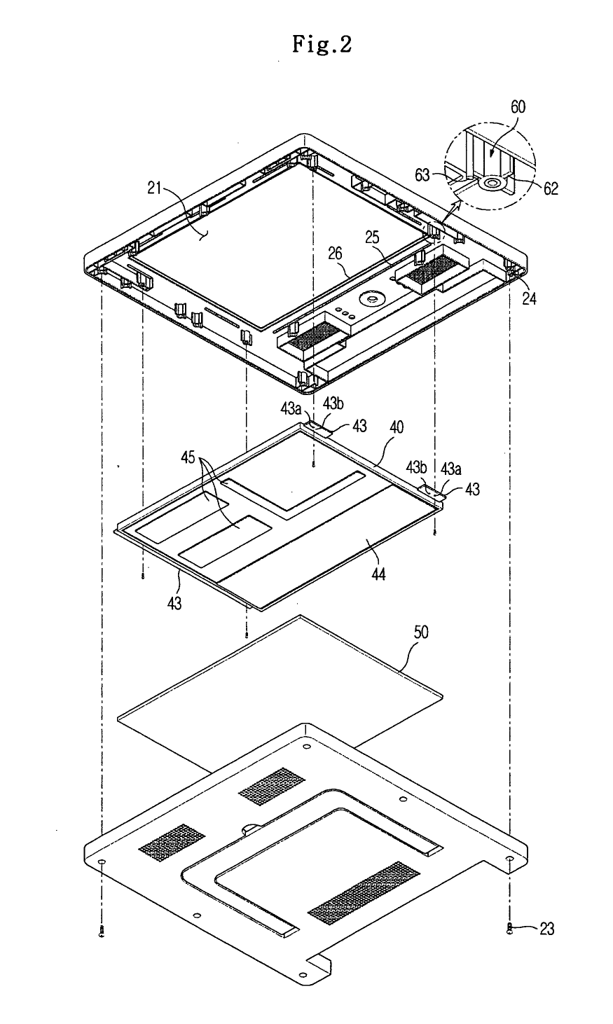

As shown in FIGS. 1 and 2, the web pad in accordance with the embodiment of the present invention includes a case unit 10 defining an internal space in which internal components are installed, an LCD module 40 attached to a front portion of the case unit 10, and a main board 50 formed in a rear portion of the LCD module 40.

The case unit 10 includes a front case 20 forming a front surface of the web pad, and a rear case 30 connected to the front case 20 and forming a rear surface of the web pad.

An opening 21 sized to receive a touch screen 41 of the LCD module 40 for exposing the touch screen 41 to the outside is defined through the central portion of the front case 20. Button holes 22 receiving buttons therein are defined in the front surface of the front case 20 below the touch screen 41. A plurality of bosses mounting various components therein protrude from the rear surface of the front case 20.

A guide portion 25 guiding the fixing position of the LCD module 40 in attachment to the front case 20 protrudes from the rear surface of the front case 20 along the circumference of the opening 21 of the front case 20. A downwardly-stepped isolating portion 26 preventing the edge of an LCD 42 from contacting the front case 20 is provided between the guide portion 25 and the opening 21, thus preventing defects from occurring on the screen 41.

In order to prevent damage to the rear case 30 from impact applied to the web pad after internal components, such as the LCD module 40 and the main board 50, are assembled, buffer members (not shown) may be attached to the rear case 30 or depressed portions (not shown) may be formed in the rear case 30, thus preventing components of the main board 50 from contacting the inner surface of the rear case 30.

Reference numerals 23 and 24 respectively represent bolts and bosses assembling the case unit 10 by attaching the front case 20 to the rear case 30.

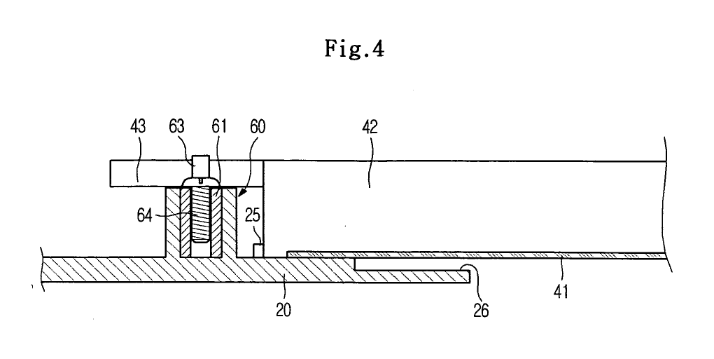

As shown in FIGS. 2 and 4, the LCD module 40 includes the LCD 42 having a rectangular panel shape, the touch screen 41 formed on a front surface of the LCD 42, an LCD frame 43 formed on the circumferential surface of the LCD 42 and provided with a plurality of fixing holes 43a fixing the LCD module 40 to the case unit 10, and an LCD printed circuit board (PCB) 44. Guide holes 43b guiding the installation position of the LCD module 40 are defined through the LCD frame 43. The guide holes 43b are formed at positions corresponding to guide protrusions 63 formed on and extending from the front case 20 and/or the fixing bosses 60, which will be described later, so that the guide protrusions 63 are inserted into the guide holes 43b when the LCD module 40 is attached to the front case 20.

The LCD module 40 further includes buffer members 45 attached to the rear surface of the LCD 42 protecting internal components from external impact.

Various components for driving the web pad of the present invention are mounted on the main board 50, and slots, into which various memory cards may be inserted, may be formed through the main board 50.

Fixing bosses 60 fixing the LCD module 40 to the case unit 10 protrude from the inner surface of the front case 20.

Four fixing bosses 60 may be formed on the inner surface of the front case 20 corresponding to corners of the LCD module 40. A nut 61 reinforcing the strength of the respective fixing boss 60 is inserted into each of the fixing bosses 60. The nuts 61, which are respectively inserted into the four fixing bosses 60, generally are formed to be of equal height. The bosses 60 and nuts 61 prevent defects on the touch screen 41 generated by pressing a portion of the circumferential surface of the LCD 42.

The nuts 61 may be made with a metal having adequate rigidity to reinforce the strength of the fixing bosses 60.

The torques of screws 64, each of which are connected to the corresponding fixing bosses 60, are uniformly maintained by inserting each of the nuts 61 into the corresponding fixing bosses 60.

A plurality of support portions 62 protrude from a cylindrical portion of each of the fixing bosses 60 to a designated length, thus supporting the corresponding fixing bosses 60. Further, each of the guide protrusions 63 may protrude upwardly from one side of each of the fixing bosses 60, thus guiding the installation position of the LCD module 40. The guide protrusions 63 may be respectively installed on the fixing bosses 60, or may protrude from the inner surface of the front case 20. Each of the guide protrusions 63 may protrude from one side of only the right or left fixing bosses 60, for example. The LCD module 40 may be positioned upon installation by fixing the LCD module 40 to the front case 20 by inserting the guide protrusions 63 into the guide holes 43b of the LCD frame 43. The LCD module 40 may then be attached to the front case 20 by respectively connecting the nuts 61 with the fixing holes 43a. The correct disposition of the LCD module 40 at the fixed position reduces defects on the touch screen 41.

Hereinafter, a process for assembling the above-described web pad of the embodiment of the present invention will be described.

First, in order to fix the LCD module 40 to the front case 20, the guide protrusions 63 of the fixing bosses 60 attached to the front case 20 are inserted into the guide holes 43b formed in the LCD frame 43. The circumferential portion of the LCD module 40 is fixed to the guide portion 25 of the front case 20, thereby connecting the nuts 61, inserted into the fixing bosses 60 of the front case 20, with the fixing holes 43a of the LCD frame 43.

Thereafter, the LCD module 40 is mounted on the front case 20 using the screws 64.

The main board 50 is connected to the rear surface of the LCD module 40, and the rear case 30 is connected to the front case 20, thereby completing the assembly of the web pad.

As apparent from the above description, the embodiment of the present invention provides a web pad, in which an LCD module is fixed to a case unit by inserting nuts into fixing bosses and then by inserting screws into the nuts, thus preventing damage to internal components including the LCD module due to breakage of the fixing bosses by external impact.

The insertion of the nuts into the fixing bosses uniformly maintains the torques of the screws, thus preventing defects on an LCD screen.

Guide protrusions, each of which is formed on the corresponding fixing bosses provided with supporting portions, are inserted into guide holes of the LCD module, thus rapidly disposing the LCD module at a correct predetermined position. Thereby, it is possible to prevent defects on a touch screen due to the failure to position the LCD module at the correct position.

Although an embodiment of the invention has been shown and described, it would be appreciated by those skilled in the art that changes may be made in this embodiment without departing from the principles and spirit of the invention, the scope of which is defined in the claims and their equivalents.

What is claimed is:

1. A web pad comprising:
a case unit having a space defined therein;
an LCD module including an LCD and a touch screen within the case unit;
a main board within the case unit;
a plurality of fixing bosses integrally connected to the case unit;
a plurality of nuts each being respectively inserted into the fixing bosses; and
a plurality of screw each being respectively connected with a corresponding nut inserted in each of the fixing bosses, to fix the LCD module to the case unit.

2. The web pad according to claim 1, wherein the nuts are made from metal.

3. The web pad according to claim 1, further comprising a plurality of support portions supporting the fixing bosses formed on each of the fixing bosses.

4. The web pad according to claim 1, further comprising a plurality of guide protrusions guiding the installation of the LCD module to a front portion of the case unit respectively formed on the case unit.

5. The web pad according to claim 4, further comprising an isolating portion preventing contact between the touch screen and the case unit formed in the case unit.

6. A web pad comprising:
an LCD module including an LCD and a touch screen;
a main board driving the LCD module;
a case unit housing the LCD module and the main board therein;
fixing bosses integrally formed on the case unit fixing the LCD module to the case unit;
a plurality of nuts each being respectively inserted into the fixing bosses, the nuts providing reinforcement of the fixing bosses to prevent damage to the fixing bosses due to impact; and
a plurality of screws each respectively connecting the LCD module to the nuts.

7. The web pad according to claim 6, further comprising at least one support portion supporting the fixing bosses, at least one of the support portions formed on each of the fixing bosses.

8. The web pad according to claim 6, further comprising guide protrusions guiding the installation of the LCD module to a front portion of the case unit formed on the case unit.

9. The web pad according to claim 4, wherein the guide protrusions protrude from each of the fixing bosses integrally connected to the case unit.

10. The web pad according to claim 8, wherein the guide protrusions protrude from the each of the fixing bosses integrally formed on the case unit.

11. The web pad according to claim 9, wherein at least one of the guide protrusions protrudes from one side of each of the fixing bosses.

12. The web pad according to claim 10, wherein at least one of the guide protrusions protrudes from one side of each of the fixing bosses.

13. The web pad according to claim 1, wherein the LCD module further includes an LCD frame having a plurality of fixing holes defined within the LCD frame, each of the fixing holes receiving one of the screws to attach the LCD module to the case unit.

14. The web pad according to claim 4, wherein the LCD module further includes an LCD frame having a plurality of guide holes defined within the LCD frame, each guide hole receiving one of the guide protrusions.

15. The web pad according to claim 1, further comprising a guide portion of the case unit protruding from a rear surface of a front portion of the case unit along a circumference of an opening defined in the case unit, the guide portion guiding installation of the LCD module.

16. A web pad, comprising:
a case unit forming a housing of the web pad;
an LCD frame;
a plurality of fixing bosses attached to a front portion of the case unit;
a plurality of nuts each being respectively inserted into the fixing bosses; and
at least one guide protrusion protruding from a side of at least one of the fixing bosses;
wherein at least one guide hole is defined within the LCD frame receiving the guide protrusion protruding from the fixing boss.

17. The web pad according to claim 16, wherein the LCD frame defines at least one fixing hole within the LCD frame and the fixing hole is connected to the fixing boss when the LCD module is installed to the case unit.

18. The web pad according to claim 16, further comprising a guide portion of the case unit protruding from a rear surface of a front portion of the case unit along a circumference of an opening defined in the case unit, the guide portion guiding installation of the LCD module.

19. The web pad according to claim 18, further comprising an isolating portion preventing contact between the touch screen and the case unit formed in the case unit between the opening and the guide portion.
